(19) United States
(12) Patent Application Publication
(10) Pub. No.: US 2011/0289929 A1
(43) Pub. Date: Dec. 1, 2011

(54) TURBOMACHINE FUEL NOZZLE

(75) Inventors: Abdul Rafey Khan, Greenville, SC (US); Kapil Kumar Singh, Clifton Park, NY (US)

(73) Assignee: GENERAL ELECTRIC COMPANY, Schenectady, NY (US)

(21) Appl. No.: 12/789,820

(22) Filed: May 28, 2010

(51) Int. Cl. F02C 9/26; F02C 7/22

(52) U.S. Cl. 60/772; 60/740

(57) ABSTRACT

A turbomachine includes a compressor, a turbine operatively coupled to the compressor, and a combustor fluidly linking the compressor and the turbine. The combustor includes at least one fuel nozzle. The at least one fuel nozzle includes a flow passage including a body having first end that extends to a second end through at least one flow channel having a flow area. A fuel inlet is provided at the first end of the body. The fuel inlet is configured to receive at least one fuel. A fuel outlet is provided at the second end of the body. A control flow passage is fluidly connected to the body between the first and second ends. The control flow passage is configured and disposed to deliver a control flow into the fuel nozzle. The control flow establishes a selectively variable effective flow area of the flow passage.

### BACKGROUND OF THE INVENTION

The subject matter disclosed herein relates to the art of turbomachines and, more particularly, to a fuel nozzle for a turbomachine.

Turbomachines typically include a compressor, a combustor and a turbine. In operation, air flows through the compressor, is compressed and supplied to the combustor. Fuel is also channeled to the combustor, mixed with the compressed air, and ignited to form combustion gases. The combustion gases are channeled to the turbine. The turbine converts thermal energy from the combustion gases to mechanical, rotational energy that is used to power the compressor as well as to produce useful work such as to operate an electrical generator. Conventional turbomachines are designed to operate on a particular fuel or family of fuels.

The regulatory requirements for low emissions from gas turbine power plants have grown more stringent over the years. Environmental agencies throughout the world are now requiring even lower rates of emissions of NOx and other pollutants from both new and existing gas turbines. Traditional methods of reducing NOx emissions from combustion turbines (water and steam injection) are limited in their ability to reach the extremely low levels required in many localities.

### BRIEF DESCRIPTION OF THE INVENTION

According to one aspect of the invention, a turbomachine includes a compressor, a turbine operatively coupled to the compressor, and a combustor fluidly linking the compressor and the turbine. The combustor includes at least one fuel nozzle. The at least one fuel nozzle includes a flow passage including a body having first end that extends to a second end through at least one flow channel having a flow area. A fuel inlet is provided at the first end of the body. The fuel inlet is configured to receive at least one fuel. A fuel outlet is provided at the second end of the body. At least one control flow passage is fluidly connected to the body between the first and second ends. The at least one control flow passage is configured and disposed to deliver at least one control flow into the fuel nozzle. The at least one control flow establishes a selectively variable effective flow area of the flow passage.

According to another aspect of the invention, a turbomachine fuel nozzle includes a flow passage including a body having first end that extends to a second end through at least one flow channel having a flow area. A fuel inlet is provided at the first end of the body. The fuel inlet is configured to receive at least one fuel. A fuel outlet is provided at the second end of the body. At least one control flow passage is fluidly connected to the body between the first and second ends. The at least one control flow passage is configured and disposed to deliver at least one control flow into the fuel nozzle. The at least one control flow establishes a selectively variable effective flow area of the flow passage.

According to yet another aspect of the invention, a method of selectively varying an effective flow area of a turbomachine fuel nozzle includes receiving at least one fuel into a fuel inlet of the fuel nozzle, guiding the at least one fuel along a flow passage including a flow channel having a flow area, introducing at least one control flow downstream of the fuel inlet, and varying an effective flow area of the flow passage with the at least one control flow.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a turbomachine including a combustor fuel nozzle in accordance with an exemplary embodiment;

FIG. 2 is a cross-sectional schematic view of a combustor fuel nozzle in accordance with one aspect of the exemplary embodiment; and

FIG. 3 is a cross-sectional schematic view of a combustor fuel nozzle in accordance with another aspect of the exemplary embodiment.

The detailed description explains embodiments of the invention, together with advantages and features, by way of example with reference to the drawings.

### DETAILED DESCRIPTION OF THE INVENTION

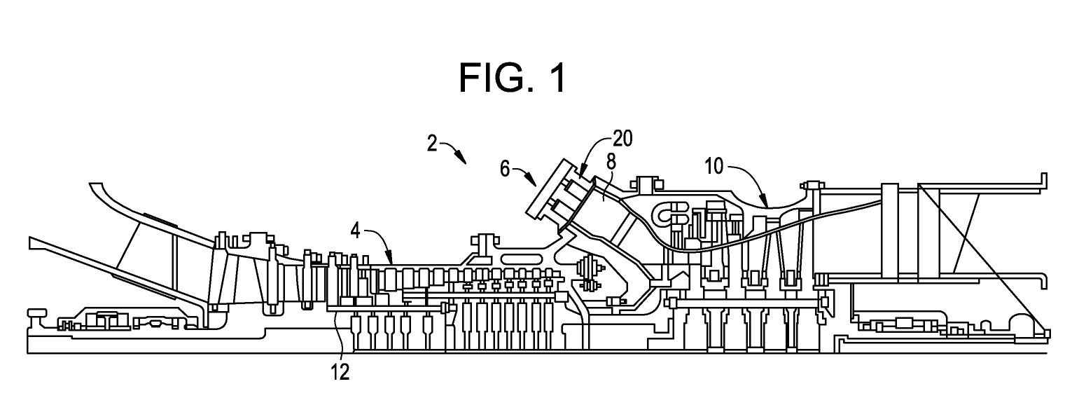

With reference to FIG. 1, a turbomachine constructed in accordance with an exemplary embodiment is indicated generally at 2. Turbomachine 2 includes a compressor 4 and a plurality of circumferentially spaced combustors, one of which is indicated at 6. Combustor 6 includes a combustion chamber 8 that channels hot gases to a turbine 10 that is operatively coupled to compressor 4 through a common compressor/turbine shaft or rotor 12.

In operation, air flows through compressor 4 such that compressed air is supplied to combustor 6. Fuel is channeled to combustion chamber 8, mixed with air, and ignited to form combustion gases. The combustion gases are channeled to turbine 10 wherein gas stream thermal energy is converted to mechanical, rotational energy. Turbine 10 is rotatably coupled to, and drives, shaft 12. It should be appreciated that the term “fluid” as used herein includes any medium or material that flows and is not limited to gas and/or air. In addition, the term fuel should be understood to include mixtures of fuels, diluents (N₂, Steam, CO₂, and the like, and/or mixtures of fuels and diluents.

Fuel is passed to combustion chamber 8 through a plurality of combustor fuel nozzles, one of which is indicated at 20. In accordance with an exemplary embodiment, combustor fuel nozzle 20 constitutes a dual fuel nozzle. More specifically, combustor fuel nozzle 20 injects a first fuel and/or a second fuel, where the two fuels may have widely disparate energy content, into combustion chamber 8. In accordance with one aspect of the exemplary embodiment natural gas may be the first fuel and syngas may be the second fuel. Further, syngas fuel may be a 20%/36%/44% combination of natural gas/hydrogen/carbon monoxide (NG/H2/CO).

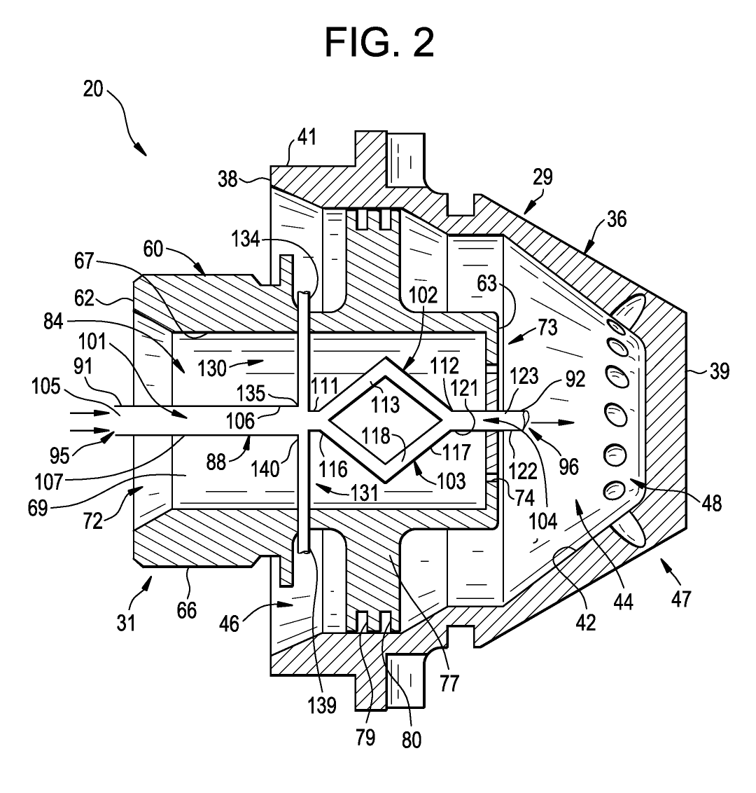

As best shown in FIG. 2, combustor fuel nozzle 20 includes an outer nozzle portion 29 and an inner nozzle portion 31. Outer nozzle portion 29 includes a body portion 36 having a first end portion 38 that extends to a second end portion 39. Body portion 36 is further shown to include an outer wall 41 and an inner wall 42 that defines a plenum 44. First end portion 38 defines an inlet portion 46 and second end portion 39 defines an outlet portion 47 having a plurality of openings 48. As shown, inner nozzle portion 31 extends into outer nozzle portion 29. More specifically, inner nozzle portion 31 extends through first end portion 38 into plenum 44 and is coupled to inner wall 42 in a manner that will be described more fully below.

Inner nozzle portion 31 includes a body section 60 having a first end section 62 that extends to a second end section 63. Body section 60 is also shown to include an outer wall 66 and an inner wall 67 that defines a plenum 69. First end section 62 defines an inlet section 72, and second end section 63 defines an outlet section 73 having a plurality of openings 74. Inner nozzle portion 31 is connected to inner wall 42 of outer nozzle portion 29 through a circumferential flange 77 having first and second seal lands 79 and 80 provided with corresponding seals (not shown). In accordance with an exemplary embodiment, combustor fuel nozzle 20 further includes a duel fuel flow passage 84 that extends through inner nozzle portion 31. As will become more fully evident below, combustor fuel nozzle 20 relies upon a Coand\check{a} effect to guide first and/or second fuels through dual fuel flow passage 84.

In accordance with an exemplary embodiment, dual fuel flow passage 84 includes a body 88 having a first end 91 that extends to a second end 92. First end 91 defines a fuel inlet 95, while second end 92 defines a fuel outlet 96 that extends though outlet section 73. Dual fuel flow passage 84 includes a first flow channel 101 that extends from fuel inlet 95, a second flow channel 102 that is fluidly coupled to first flow channel 101, a third flow channel 103 that is also fluidly coupled to first flow channel 101, and a fourth flow channel 104 that fluidly links second and third flow channels 102 and 103 with fuel outlet 96.

First flow channel 101 includes a first effective cross-sectional area and extends from first end zone 105 arranged adjacent to fuel inlet 95 to a second end zone 106 through an intermediate portion 107. Second flow channel 102 includes second effective cross-sectional area and extends from a first end zone 111 that is linked to second end zone 106 of first flow channel 101 to a second end zone 112 through an intermediate portion 113. Third flow channel 103 includes a third effective cross-sectional area and extends from a first end zone 116 that is also linked to second end zone 106 of first flow channel 101 to a second end zone 117 through an intermediate portion 118. Fourth flow channel includes a fourth effective cross-sectional area and extends from a first end zone 121 that is linked to second end zone 112 of second flow channel 102 and second end zone 117 of third flow channel 103 to a second end zone 122 through an intermediate portion 123.

The first, second, third, and fourth effective cross-sectional areas are distinct in order to provide desired pressures for first and second fuels to enhance combustion. More specifically, the first fuel is passed through second flow channel 102 having the second effective cross-section area in order to achieve desired pressure levels that promote more complete combustion of the first fuel, while the second fuel is passed through third flow channel 103 having the third effective cross-sectional area in order to achieve desired pressure levels that lead to more compete combustion of the second fuel. Of course it should be understood that the first and second fuels could be mixed, or a third fuel could be utilized and be passed through the second and third flow channels 102 and 103. For example, the first and second fuels could be combined to form various fuel mixtures.

In order to direct the first and second fuels to respective ones of the second and third flow channels 102 and 103, a fluid, such as one of the first and second fuel, or diluents, is introduced at second end zone 106 of first flow channel 101. As will be detailed more fully below, the fluid introduced at this point creates a Coand\check{a} effect that guides the one of the first and second fuels into the corresponding ones of the second and third flow channels 102 and 103. More specifically, combustor fuel nozzle 20 includes a first control flow passage 130 that is configured and disposed to direct a control flow into second end zone 106 causing the second fuel to flow into third flow channel 103, and a second control flow passage 131 that is configured and disposed to guide a second control flow into second end zone 106 causing the first fuel to flow into the second flow channel 102 as will be detailed more fully below. First and second control flow passages 130 and 131 are connected to a control flow circuit (not shown). In the exemplary embodiment shown, first control flow passage 130 is positioned opposite to second control flow passage 131. However, it should be understood by one of ordinary skill in the art that first and second control flow passages 130 and 131 could be an angles relative to one another and/or first flow channel 101 or axially offset one from another.

First control flow passage 130 includes a first end segment 134 that extends through body section 60 of inner nozzle portion 31 to a second end segment 135 that is fluidly connected with second end zone 106 of first flow channel 101. Similarly, second control flow passage 131 includes a first end segment 139 that extends through body section 60 of inner nozzle portion 31 to a second end segment 140 that is fluidly connected to second end zone 106 of first flow channel 101. With this arrangement, when the second fuel is introduced into fuel inlet 95, a first fluid or control flow passing through first control flow passage 130 urges the second fuel to flow into third flow channel 103. Similarly, when the first fuel is introduced into fuel inlet 95, a second fluid or control flow passing through second control flow passage 131 urges the first fuel to flow into second flow channel 102. As noted above, the first and second control flows can constitute the first and second fuels, diluents, other fluids, or combinations thereof.

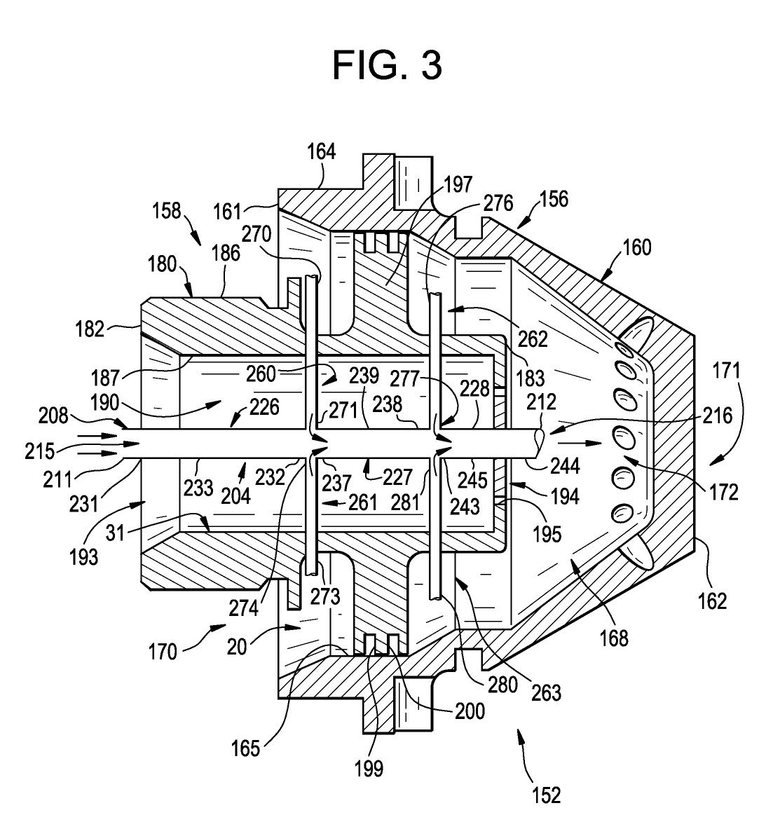

Reference will now be made to FIG. 3 in describing a combustor fuel nozzle 152 constructed in accordance with another aspect of the exemplary embodiment. Combustor fuel nozzle 152 includes an outer nozzle portion 156 and an inner nozzle portion 158. Outer nozzle portion 156 includes a body portion 160 having a first end portion 161 that extends to a second end portion 162. Body portion 160 is further shown to include an outer wall 164 and an inner wall 165 that defines a plenum 168. First end portion 161 defines an inlet portion 170 and second end portion 162 defines an outlet portion 171 having a plurality of openings 172. As shown, inner nozzle portion 158 extends into outer nozzle portion 156. More specifically, inner nozzle portion 158 extends through first end portion 161 into plenum 168 and is coupled to inner wall 165 in a manner that will be described more fully below.

Inner nozzle portion 158 includes a body section 180 having a first end section 182 that extends to a second end section 183. Body section 180 is also shown to include an outer wall 186 and an inner wall 187 that defines a plenum 190. First end section 182 defines an inlet section 193, and second end section 183 defines an outlet section 194 having a plurality of openings 195. Inner nozzle portion 158 is connected to inner wall 165 of outer nozzle portion 156 through a circumferential flange 197 having first and second seal lands 199 and 200 provided with corresponding seals (not shown). In accordance with an exemplary embodiment, combustor fuel nozzle 152 further includes a dual fuel flow passages 204 that extends through inner nozzle portion 158. As will become more fully evident below, combustor fuel nozzle 152 relies upon a Coand\check{a} effect to guide first and/or second fuels through dual fuel flow passage 204.

In accordance with an exemplary embodiment, dual fuel flow passage 204 includes a body 208 having a first end 211 that extends to a second end 212. First end 211 defines a fuel inlet 215, while second end 212 defines a fuel outlet 216 that extends though outlet section 194. Dual fuel flow passage 204 includes a first flow channel 226 that extends from fuel inlet 215, a second flow channel 227 that is fluidly coupled to first flow channel 226, and a third flow channel 228 that is fluidly coupled to second flow channel 227 and fuel outlet 216.

First flow channel 226 includes a first effective cross-sectional area and extends from first end zone 231 arranged adjacent to fuel inlet 215 to a second end zone 232 through an intermediate portion 233. Second flow channel 227 includes second effective cross-sectional area and extends from a first end zone 237 that is linked to second end zone 232 of first flow channel 226 to a second end zone 238 through an intermediate portion 239. Third flow channel 228 includes a third effective cross-sectional area and extends from a first end zone 243 that is linked to second end zone 238 of second flow channel 227 to a second end zone 244 through an intermediate portion 245. In accordance with the exemplary embodiment, the first, second, and third effective cross-sectional areas are similar but are selectively adjustable in order to provide desired pressures for first and second fuels to promote a more complete combustion.

In order to promote desired pressures for the first and second fuels, dual fuel flow passage 204 includes a first control flow passage 260 and a second control passage 261 that direct first and second control flows to selectively adjust the effective cross-sectional areas of second flow channel 227. In the exemplary embodiment shown, first control flow passage 260 is aligned with and positioned opposite to second control flow passage 261. However, it should be understood by one of ordinary skill in the art that first and second control flow passages 260 and 261 could be arranged at angles relative to one another and/or second flow channel 227 or axially offset one from another. Dual fuel flow passage 204 also includes a third control flow passage 262 and a fourth control flow passage 263 that direct third and fourth control flows to selectively adjust the effective cross-sectional areas of third flow channel 228. In the exemplary embodiment shown, third control flow passage 262 is aligned with and positioned opposite to fourth control flow passage 263. However, it should be understood by one of ordinary skill in the art that third and fourth control flow passages 262 and 263 could be arranged at angles relative to one another and/or third flow channel 228 or axially offset one from another. First, second, third, and fourth control flow passages 260-263 are operatively connected to a control flow circuit (not shown) that delivers the control flow. The control flow includes the first fuel, the second fuel, diluents or combinations thereof.

In a manner similar to that described above, third control flow passage 262 is aligned with and positioned opposite fourth control flow passage 263. First control flow passage 260 includes a first end segment 270 that extends through body section 180 of inner nozzle portion 158 to a second end segment 271 that is fluidly connected with second end zone 232 of first flow channel 226. Similarly, second control flow passage 261 includes a first end segment 273 that extends through body section 180 of inner nozzle portion 158 to a second end segment 274 that is fluidly connected with second end zone 232 of first flow channel 226. Third control flow passage 262 includes a first end segment 276 that extends through body section 180 of inner nozzle portion 158 to a second end segment 277 that is fluidly connected with second end zone 238 of second flow channel 227, and fourth control flow passage 263 includes a first end segment 280 that extends through body section 180 of inner nozzle portion 158 to a second end segment 281 that is fluidly connected with second end zone 238 of second flow channel 227.

With this arrangement, when the first fuel is introduced into fuel inlet 215, first and second control flows are passed into first and second control flow passages 260 and 261, respectively. The first and second control flows enter into second flow channel and, relying on the Coand\check{a} effect, pass along internal surfaces thereof to selectively adjust the effective cross-sectional area. Similarly, if desired, third and fourth control flows are passed through third and fourth control flow passages 262 and 263, enter into third flow channel and, relying on the Coand\check{a} effect, pass along internal surfaces thereof to selectively adjust the effective cross-sectional area. In this manner, desired pressures are achieved for the first fuel in order to promote more complete combustion. When using the second fuel, the control flows are adjusted to achieve an effective cross-sectional area for the second and third flow channels 227 and 228 to establish desired pressures for the second fuel in order to promote more complete combustion.

At this point it should be understood that the exemplary embodiment provides a fuel nozzle for a turbomachine that can be selectively operated using a wide range of wobbe fuels without requiring multiple nozzles, nozzle changes or expensive/complicated plumbing/valving. Moreover, the fuel nozzle in accordance with the exemplary embodiment can be selectively adjusted to achieve desired operating pressures thereby enabling turbomachine operation using syngas, diluted fuel streams or high wobbe fuels such as propane, butane and the like. The flexibility to use a wide range of fuels leads to lower NOx emissions without requirement of costly and complicated systems that allow for fuel changes.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a compressor;
a turbine operatively coupled to the compressor;
a combustor fluidly linking the compressor and the turbine, the combustor including at least one fuel nozzle, the at least one fuel nozzle comprising:
a flow passage including a body having a first end that extends to a second end through at least one flow channel having a flow area;
a fuel inlet provided at the first end of the body, the fuel inlet being configured to receive at least one fuel;
a fuel outlet provided at the second end of the body; and
at least one control flow passage fluidly connected to the body between the first and second ends, the at least one control flow passage being configured and disposed to deliver at least one control flow into the fuel nozzle, the at least one control flow establishing a selectively variable effective flow area of the flow passage.

2. The turbomachine according to claim 1, wherein the at least one control flow passage includes a first control flow passage and a second control flow passage, the first control flow passage delivering a first control flow into the fuel nozzle, and the second control flow passage delivering a second control flow into the fuel nozzle.

3. The turbomachine according to claim 2, wherein the first control flow passage is aligned with, and positioned opposite to, the second control flow passage.

4. The turbomachine according to claim 2, wherein the at least one flow channel includes a first flow channel having a first effective area and a second flow channel having a second effective area, the first control flow selectively guiding the at least one fuel into the first flow channel, and the second control flow selectively guiding the at least one fuel into the second flow channel.

5. The turbomachine according to claim 2, wherein the at least one control flow passage includes a third control flow passage and a fourth control flow passage, the third control flow passage delivering a third control flow into the fuel nozzle, and the fourth control flow passage delivering a fourth control flow into the fuel nozzle, the third and fourth control flows further establishing the selectively variable effective flow area of the flow passage.

6. The turbomachine according to claim 2, wherein the at least one fuel received at the fuel inlet includes a first fuel and a second fuel, the at least one control flow being one of the first fuel, the second fuel, a diluent and mixtures thereof.

7. A turbomachine fuel nozzle comprising:
a flow passage including a body having first end that extends to a second end through at least one flow channel having a flow area;
a fuel inlet provided at the first end of the body, the fuel inlet being configured to receive at least one fuel;
a fuel outlet provided at the second end of the body; and
at least one control flow passage fluidly connected to the body between the first and second ends, the at least one control flow passage being configured and disposed to deliver at least one control flow into the fuel nozzle, the at least one control flow establishing a selectively variable effective flow area of the flow passage.

8. The turbomachine fuel nozzle to claim 7, wherein the at least one control flow passage includes a first control flow passage and a second control flow passage, the first control flow passage delivering a first control flow into the fuel nozzle, and the second control flow passage delivering a second control flow into the fuel nozzle.

9. The turbomachine fuel nozzle according to claim 8, wherein the first control flow passage is aligned with, and positioned opposite to, the second control flow passage.

10. The turbomachine fuel nozzle according to claim 8, wherein the at least one flow channel includes a first flow channel having a first effective area and a second flow channel having a second effective area, the first control flow selectively guiding the at least one fuel into the first flow channel and the second control flow selectively guiding the at least one fuel into the second flow channel.

11. The turbomachine fuel nozzle according to claim 8, wherein the at least one control flow passage includes a third control flow passage and a fourth control flow passage, the third control flow passage delivering a third control flow into the fuel nozzle and the fourth control flow passage delivering a fourth control flow into the fuel nozzle, the third and fourth control flows further establishing the selectively variable effective flow area of the flow passage.

12. The turbomachine fuel nozzle according to claim 8, wherein the at least one fuel received at the fuel inlet includes a first fuel and a second fuel, the at least one control flow being one of the first fuel, the second fuel, a diluent and mixtures thereof.

13. A method of selectively varying an effective flow area of a turbomachine fuel nozzle, the method comprising:
receiving at least one fuel into a fuel inlet of the fuel nozzle;
guiding the at least one fuel along a flow passage including a flow channel having a flow area;
introducing at least one control flow downstream of the fuel inlet; and
varying an effective flow area of the flow passage with the at least one control flow.

14. The method of claim 13, wherein introducing at least one control flow includes guiding first and second control flows into the fuel nozzle.

15. The method of claim 13, wherein varying an effective flow area of the flow passage includes fluidically guiding the at least one fuel into a first fuel channel having a first area and a second fuel channel having a second area.

16. The method of claim 15, wherein fluidically guiding the at least one fuel includes directing the at least one fuel into the first fuel channel with the first control flow and directing the at least one fuel into the second fuel channel with the second control flow.

17. The method of claim 16, wherein the fuel inlet receives a first fuel and a second fuel, the first control flow comprising one of the first fuel and a diluent, and the second control flow includes one of the first fuel, the second fuel and a diluent.

18. The method of claim 13, wherein the fuel inlet receives a first fuel and a second fuel.

19. The method of claim 18, wherein introducing at least one control flow includes guiding first, second, third, and fourth control flows into the fuel nozzle, the first and second control flows including at least one of the first fuel and a diluent and the second control flow includes at least one of the second fuel and a diluent.

20. The method of claim 18, wherein the first and second control flows establish a first effective flow area and the third and fourth control flows establish a second effective flow area.
